(19) United States
(12) Patent Application Publication
(10) Pub. No.: US 2023/0155276 A1
(43) Pub. Date: May 18, 2023

(54) MULTI-STANDARD INTEGRATED ANTENNA

(71) Applicant: COMBA TELECOM TECHNOLOGY (GUANGZHOU) LIMITED, Guangzhou (CN)

(72) Inventors: Peitao Liu, Guangzhou (CN); Binlong Bu, Guangzhou (CN); Shanqiu Sun, Guangzhou (CN); Fengzhang Xue, Guangzhou (CN); Litao Chen, Guangzhou (CN); Zhanjun Lai, Guangzhou (CN); Hongbin Duan, Guangzhou (CN); Mingchao Li, Guangzhou (CN); Guosheng Su, Guangzhou (CN); Yifan Li, Guangzhou (CN); Mingda Huang, Guangzhou (CN); Qinyuan Wang, Guangzhou (CN); Songdong Fan, Guangzhou (CN)

(73) Assignee: COMBA TELECOM TECHNOLOGY (GUANGZHOU) LIMITED, Guangzhou (CN)

(21) Appl. No.: 16/967,593

(22) PCT Filed: Feb. 2, 2019
(86) PCT No.: PCT/CN2019/074574

§ 371 Date: Apr. 8, 2022

(30) Foreign Application Priority Data
Feb. 6, 2018 (CN) 201810119285.9
Feb. 6, 2018 (CN) 201810119754.7

(51) Int. Cl. H01Q 1/24; H01Q 19/10; H01Q 1/42; H01Q 21/24

(52) U.S. Cl. CPC H01Q 1/246; H01Q 19/10; H01Q 1/42; H01Q 21/24

(57) ABSTRACT

The present application provides a multi-standard-integrated antenna, comprising: a first antenna system having a Massive multiple-input multiple-output (MIMO) array; a second antenna system which has an antenna array and which operates at a set network standard, said second antenna system is a passive antenna system or an active antenna system; the set network standard is at least one of a 4G network standard, a 3G network standard, and a 2G network standard; the first antenna system and the second antenna system share a radome. The multi-standard-integrated antenna achieves an integrated design of two or more antenna systems comprising a Massive MIMO array antenna system; the structure is compact, and not only is compatibility with various communication systems improved, but it is also easier to reuse existing base stations; base station equipment is simplified, and surface resources are thoroughly conserved, the difficulty of network planning is reduced, the cost of operators is reduced, and the convenience of maintenance is increased.

### TECHNICAL FIELD

The present application relates to the field of communication technology, more specifically to a multi-standard integrated antenna.

### BACKGROUND

The rapid growth of data service in mobile communication promotes the continuous development of communication technology. In order to reduce the cost of network construction, there is a common phenomenon at home and abroad that the second generation (2G), the third generation (3G) and the fourth generation (4G) network coexist. When using common narrow band antennas, many antennas are required to be arranged for one base station, which greatly increases the system complexity and property costs.

On the other hand, with the continuous development of mobile communication industry, the study on the fifth generation (5G) with Massive MIMO array (i.e. large-scale antenna array) has been launched. However, the applicant found that most of the current studies on 5G communication technology only involve 5G antenna itself. However, no matter for the above 2G antenna, 3G antenna, 4G antenna, or for the 5G antenna which is under key study at present, there are still some challenges, for example, it's not easy to change the structure and construction for the assembled products, and it's hard for maintenance, etc. In addition, since the investment of network construction is huge for the operators, maximization of the return on investment should to be considered. The 2G antenna, 3G antenna, 4G antenna and 5G antenna are bound to coexist for a long time. On the one hand, it will greatly increase the investment of the network construction and the use cost, and on the other hand, it will be more difficult for site selection for the network construction.

### SUMMARY

The technical problem to be solved by the present application is to provide a multi-standard integrated antenna which is compatible with two or more antenna systems to realize an integrated design.

In order to solve the above technical problem, the technical schemes adopted by the multi-standard integrated array antenna of the present application are as follows:

A multi-standard integrated antenna comprises:

a first antenna system with a Massive MIMO array;

a second antenna system with an antenna array and operating in a set network standard, the second antenna system is a passive antenna system or an active antenna system, and the set network standard is at least one of the 4G network standard, 3G network standard and 2G network standard;

the first antenna system and the second antenna system share a radome.

Further, the multi-standard integrated antenna is a multi-standard integrated array antenna, and the second antenna system is a passive antenna system; or,

the multi-standard integrated antenna is a multi-standard integrated active antenna, and the second antenna system is an active antenna system.

Further, the Massive MIMO array includes:

a plurality of sub-arrays, which are arranged along a plurality of first reference axes to form a M×N array, wherein M and N are natural numbers which are ≥1;

if M is set as the number of columns and N is set as the number of rows, then: m≥4, n≥1;

the sub-array includes at least one first radiation unit which is arranged spaced along the corresponding first reference axis.

Further, in the Massive MIMO array, the number of the first radiation units of at least one of the sub-arrays is different from the number of the first radiation units of the rest sub-arrays.

Further, a distance between columns of the Massive MIMO array is 0.4-0.6λ;

a distance between rows of two adjacent first radiation units is 0.5-0.9λ;

wherein, λ is a wavelength corresponding to a center frequency of a operating frequency band of the first radiation unit.

Further, when the operating frequency band of the first radiation unit is <1 GHz, the sub-array includes one first radiation unit; when the operating frequency band of the first radiation unit is ≥1 GHz, the sub-array includes at least two first radiation units.

Further, the distance between the first radiation unit and the radome is ≤¼λ, wherein λ is the wavelength corresponding to a center frequency of the operating frequency band of the first radiation unit.

Further, the antenna array is arranged into a column by a plurality of second radiation units which are spaced along a second reference axis;

or, the antenna array is arranged into two columns by a plurality of the second radiation units spaced along two third reference axes;

or, the antenna array is arranged into a column by a plurality of low-frequency radiation units and a plurality of high-frequency radiation units along a fourth reference axis, wherein a portion of the high-frequency radiation units and the low-frequency radiation units are coaxially nested;

or, the antenna array is arranged into two columns by a plurality of low-frequency radiation units and a plurality of high-frequency radiation units along the two fifth reference axes; wherein a portion of the high-frequency radiation units and the low-frequency radiation units are coaxial nested.

Further, the operating frequency band of the second radiation unit is 690-960 MHZ or 1.4-2.2 GHZ or 1.7-2.7 GHZ.

Further, the operating frequency band of the low-frequency radiation unit is 690-960 MHZ, and the operating frequency band of the high-frequency radiation unit is 1.4-2.2 GHZ or 1.7-2.7 GHZ.

Further, the distance between the second radiation unit and the radome is ≤¼λ, wherein λ is the wavelength corresponding to a center frequency of the operating frequency band of the second radiation unit.

Further, the distance between the low-frequency radiation unit and the radome is ≤¼λ, wherein λ is the wavelength corresponding to a center frequency of the operating frequency band of the low-frequency radiation unit.

Further, when the multi-standard integrated antenna is a multi-standard integrated array antenna, the first antenna system further includes a first power divider network, a phase shifter and a calibration network which are connected to the Massive MIMO array, and includes a filter and a RF transceiver component of active system which are connected to the calibration network; the second antenna system further includes a second power divider network and a phase shifter which are connected to the antenna array;

or, when the multi-standard integrated antenna is a multi-standard integrated active antenna, the first antenna system further includes a first power divider network and a calibration network which are connected to the Massive MIMO array, and includes a filter and a RF transceiver component of active system which are connected to the calibration network; the active antenna system includes a second power divider network, a phase shifter and a RRU which are connected to the antenna array.

Further, the multi-standard integrated antenna further includes a first reflecting plate and a second reflecting plate which are arranged successively along the longitudinal direction of the radome; the Massive MIMO array is provided on the first reflecting plate and the antenna array is provided on the second reflecting plate.

Further, the first reflecting plate and the second reflecting plate can be detachably connected together;

or, the first reflecting plate and the second reflecting plate are integrally molded to form a shared reflecting plate.

Based on the above technical scheme, the multi-standard integrated antenna of the present application has at least the following beneficial effects compared with the prior art.

The multi-standard integrated antenna of the present application realizes an integrated design of two or more antenna systems including Massive MIMO array antenna system. The structure is compact. It not only improves the compatibility of various communication systems, but also makes it easier to reuse the existing base stations, thus it significantly simplifies the base station disposition. It is conducive to fully saving the resource of platform where the antennas are located, reducing the difficulty of network planning, reducing the construction cost of operators and improving the convenience of later maintenance.

### DESCRIPTION OF DRAWINGS

FIG. 1 is a first structural schematic diagram of a multi-standard integrated antenna provided by an embodiment of the present application, where the multi-standard integrated antenna can be a multi-standard integrated array antenna or a multi-standard integrated active antenna;

FIG. 2 is a second structural schematic diagram of the multi-standard integrated antenna provided by an embodiment of the present application;

FIG. 3 is a third structural schematic diagram of the multi-standard integrated antenna provided by an embodiment of the present application;

FIG. 4 is a fourth structural schematic diagram of the multi-standard integrated antenna provided by an embodiment of the present application;

FIG. 5 is a first structural schematic diagram of a Massive MIMO array in the multi-standard integrated antenna provided by an embodiment of the present application;

FIG. 6 is a second structural schematic diagram of the Massive MIMO array in the multi-standard integrated antenna provided by an embodiment of the present application;

FIG. 7 is a third structural schematic diagram of the Massive MIMO array in the multi-standard integrated antenna provided by an embodiment of the present application;

FIG. 8 is a fourth structural schematic diagram of the Massive MIMO array in the multi-standard integrated antenna provided by an embodiment of the present application;

FIG. 9 is a fifth structural schematic diagram of the Massive MIMO array in the multi-standard integrated antenna provided by an embodiment of the present application;

FIG. 10 is a local structural schematic diagram of a position where the first antenna system is located in the multi-standard integrated antenna provided by an embodiment of the present application;

FIG. 11 is a local structural schematic diagram of a position where the second antenna system is located in the multi-standard integrated array antenna provided by an embodiment of the present application;

FIG. 12 is a local structural schematic diagram of the position where the second antenna system is located in the multi-standard integrated active antenna provided by an embodiment of the present application.

### DESCRIPTION OF REFERENCE NUMERALS

100: Radome, 110: First sidewall, 120: Second sidewall, 130: Third sidewall, 140: Fourth sidewall, 200: First antenna system, 210: First reflecting plate, 220: Massive MIMO array, 221: Sub-array, 221a: First radiation unit, 230: Calibration network, 240: Filter, 250: RF transceiver component of an active system, 300: Second antenna system, 310: Second reflecting plate, 320: Antenna array, 321: Second radiation unit, 322: Low-frequency radiation unit, 323: High-frequency radiation unit, d1: the distance between columns of Massive MIMO array, d2: the distance between rows of two adjacent first radiation units, d3: the distance between a first radiation unit and a radome, d4: the distance between a second radiation unit or low-frequency radiation unit and a radome, 330: Phase shifter, 340: RRU, 400: Heat dissipation module.

### DETAILED DESCRIPTION

In order to make the technical problems to be solved, technical scheme and beneficial effects more clearly, the present application is further described in combination with the accompanying drawings and embodiments. It should be understood that the specific embodiments described herein are only for the purpose of explaining the present application and not intended to limit the present application.

It should be noted that when a unit is referred to be “fixed” or “provided” on another unit, it may be directly on the other unit or there may be an intermediate unit at the same time. When a unit is referred to be “connected to” another unit, it can also be connected directly to another unit, or there may be an intermediate unit at the same time.

In the description of the present application, it should be understood that the terms “first” and “second” are only used for the purpose of description, and cannot be understood as indicating or implying relative importance or implicitly indicating the quantity of the indicated technical features. Thus, the features defined as “first” and “second” may explicitly or implicitly include one or more of the features. In the description of present application, “a plurality of” means two or more, unless otherwise specified.

In addition, the terms “length”, “width”, “up”, “down”, “front”, “back”, “left”, “right”, “vertical”, “horizontal”, “top”, “bottom”, “inside”, “outside”, “lateral” and “longitudinal” are based on the relationship of orientation or position shown in the accompanying drawings for the purpose of describing the present application and simplifying the description, rather than indicating or implying that the device or unit in question must have a specific orientation, be constructed and operated in a specific orientation, and therefore cannot be understood as a limitation of the present application.

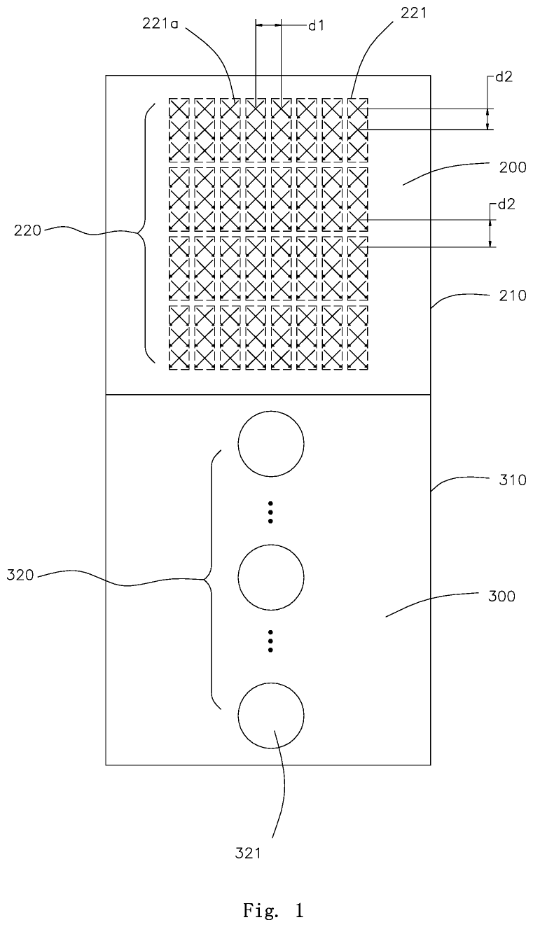

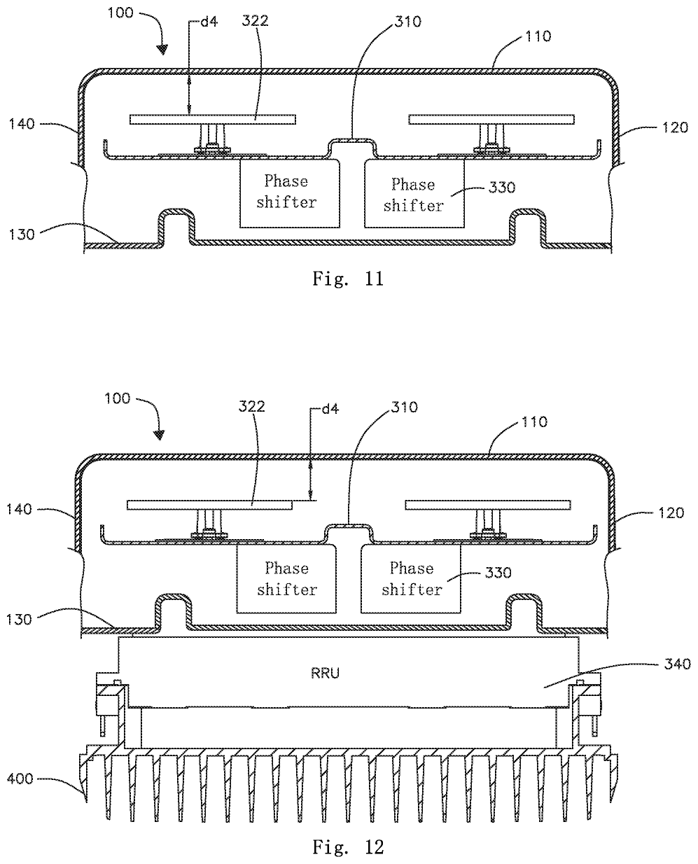

Referring to FIG. 1 to FIG. 10, the structures of a multi-standard integrated antenna provided by embodiments of the present application are schematically shown. The multi-standard integrated antenna can be a multi-standard integrated array antenna or a multi-standard integrated active antenna. FIG. 11 shows a local structural schematic diagram of the position where the second antenna system is located in the multi-standard integrated array antenna provided by an embodiment of the present application. FIG. 12 shows a local structural schematic diagram of the position where the second antenna system is located in the multi-standard integrated active antenna provided by an embodiment of the present application. As seen from the figures, the multi-standard integrated antenna system includes: a first antenna system 200 with a Massive MIMO array 220; a second antenna system 300 with an antenna array 320 and operating in a set network standard. The second antenna system 300 can be a passive antenna system when the multi-standard integrated antenna is a multi-standard integrated array antenna. The second antenna system 300 can be an active antenna system when the multi-standard integrated antenna is a multi-standard integrated active antenna system. The set network standard is at least one of the 4G network system, 3G network system and 2G network system. The first antenna system 200 and the second antenna system 300 share a radome 100.

The second antenna system 300 includes several cases as following:

The first case: the second antenna system 300 is an antenna system operating in 4G network standard, or 3G network standard or 2G network standard. Then, the following can be implemented correspondingly by the multi-standard integrated array antenna or active antenna: being compatible with 5G and 4G network application scenarios so as to realize an integrated design of 5G and 4G antenna systems; or, being compatible with 5G and 3G network application scenarios to realize an integrated design of 5G and 3G antenna systems; or, being compatible with 5G and 2G network application scenarios to realize an integrated design of 5G and 2G antenna systems. That is, the multi-standard integrated antenna can be used in an integrated scheme which is compatible with two antenna systems for different network standards. The integration of two antenna systems can thus be achieved in a compact structure and the difficulty of network planning is reduced. Preferably, in the embodiment of multi-standard integrated array antenna, the above 4G antenna system, 3G antenna system and 2G antenna system are all passive antenna systems. Preferably, in the embodiment of multi-standard integrated active antenna, the above 4G antenna system, 3G antenna system and 2G antenna system are all active antenna systems.

The second case: the second antenna system 300 includes any two of the antenna systems which are operating in 4G network standard, 3G network standard and 2G network standard. Then the following can be implemented correspondingly by the multi-standard integrated array antenna or active antenna: being compatible with 5G, 4G and 3G network application scenarios to realize an integrated design of 5G, 4G and 3G antenna system; or, being compatible with 5G, 4G and 2G network application scenarios to realize an integrated design of 5G, 4G and 2G antenna system; or, being compatible with 5G, 3G and 2G network application scenarios to realize an integrated design of 5G, 3G and 2G antenna system. That is, the multi-standard integrated antenna can be used in an integrated scheme which is compatible with three antenna systems for different network standards. The integration of three antenna systems can thus be achieved with a compact structure and can be flexibly configured to meet the demand of different product combinations. Accordingly, it is easier to reuse the existing base station, so as to significantly simplify the base station disposition. So the resources are further saved and the investment and use cost are reduced. Preferably, in the embodiment of multi-standard integrated array antenna, at least one of the above 4G antenna system and 3G antenna system is a passive antenna system, or at least one of the above 4G antenna system and 2G antenna system is a passive antenna system, or at least one of the above 3G antenna system and 2G antenna system is a passive antenna system. Preferably, in the embodiment of multi-standard integrated active antenna, the above 4G antenna system and 3G antenna system are both active antenna systems, or the above 4G antenna system and 2G antenna system are both active antenna systems, or the above 3G antenna system and 2G antenna system are both active antenna systems.

The third case: the second antenna system 300 includes an antenna system operating in 4G network standard, an antenna system operating in 3G network standard and an antenna system operating in 2G network standard. Then the multi-standard integrated array antenna or active antenna can be compatible with 5G, 4G, 3G and 2G network application scenarios to realize an integrated design of 5G, 4G, 3G and 2G antenna systems. Such integrated scheme which is compatible with four network antenna systems can achieve the integration of four antenna systems in a compact structure. With such integrated scheme, the quantity of antennas used for base stations can be greatly reduced, so that the resources are saved, the cost of station deployment is reduced, and the convenience of operation and maintenance is improved. Preferably, in the embodiment of multi-standard integrated array antenna, at least one of the above 4G antenna system, 3G antenna system and 2G antenna system is a passive antenna system. Preferably, in the embodiment of multi-standard integrated active antenna, the above 4G antenna system, 3G antenna system and 2G antenna system are all active antenna systems.

The multi-standard integrated antenna can realize an integrated design of two or more antenna systems including Massive MIMO array antenna system. The structure is compact. It not only improves the compatibility of various communication systems, but also makes it easier to reuse existing base stations, so as to significantly simplify the base station disposition. It is conducive to fully saving the resource of platform where the antennas are located, reducing the difficulty of network planning, reducing the construction cost of operators and improving the convenience of later maintenance.

As a preferred embodiment of the present application, the Massive MIMO array 220 includes: a plurality of sub-arrays 221, which are arranged along several first reference axes (not shown) to form a M×N array, where M and N are natural numbers which are ≥1. If M is set as the number of columns and N is set as the number of rows, then: M≥4, N≥1. The sub-array 221 includes at least one first radiation unit 221a which is arranged spaced along the corresponding first reference axis.

A variety of preferred arraying patterns of Massive MIMO array 220 are described in detail as below.

The sub-array 221 preferably includes 2, 3, 6 or 12 first radiation units 221a which are arranged spaced along the corresponding first reference axis. Specifically, the following four arraying patterns are included.

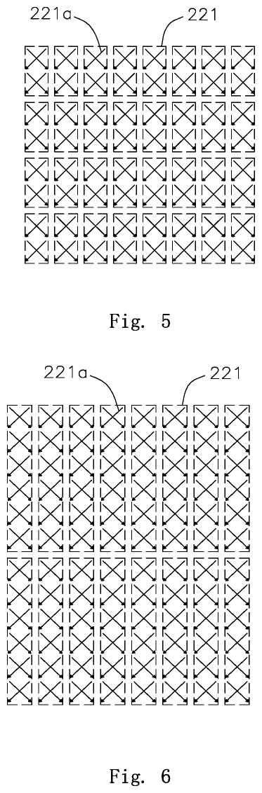

The first arraying pattern: referring to FIG. 5, a sub-array 221 is formed by two first radiation units 221a arranged spaced along a first reference axis (not shown), and a plurality of sub-arrays 221 are arranged into a M×N Massive MIMO array 220. Specifically, in the embodiment shown in FIG. 5, M is 8 and N is 4. The first antenna system 200 with this arraying pattern can form 64 channels to realize horizontal and vertical beam scanning.

The second arraying pattern: referring to FIG. 1 to FIG. 4, a sub-array 221 is formed by three first radiation units 221a which are arranged spaced along a first reference axis, and a plurality of sub-arrays 221 are arranged into a M×N Massive MIMO array 220. Specifically, in the embodiments shown in FIG. 1 to FIG. 4, M is 8 and N is 4. The first antenna system 200 of the arraying pattern can also form 64 channels, which can realize horizontal and vertical beam scanning with higher gain than the first arraying pattern.

The third arraying pattern: referring to FIG. 6, a sub-array 221 is formed by six first radiation units 221a which are arranged spaced along a first reference axis, and a plurality of sub-arrays 221 are arranged into a M×N Massive MIMO array 220. Specifically, in the embodiment shown in FIG. 6, M is 8 and N is 2. The first antenna system 200 of the arraying pattern can form 32 channels to realize horizontal and vertical beam scanning.

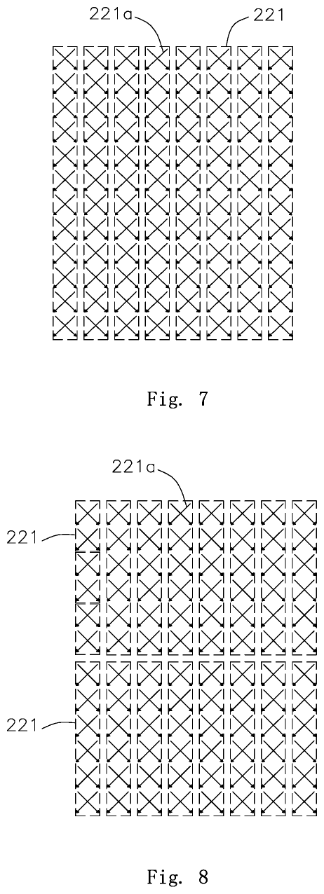

The fourth arraying pattern: referring to FIG. 7, a sub-array 221 is formed by twelve first radiation units 221a which are arranged spaced along a first reference axis, and a plurality of sub-arrays 221 are arranged into a M×N Massive MIMO array 220. Specifically, in the embodiment shown in FIG. 7, M is 8 and N is 1. The first antenna system 200 in the arraying pattern can form 16 channels to realize horizontal beam scanning.

In the embodiments of the present application, it is preferred that when the operating frequency band of the first radiation unit is ≥1 GHz, the sub-array includes at least two first radiation units; when the operating frequency band of the first radiation unit is <1 GHz, the above sub-array preferably includes only one radiation unit, so as to better apply to the corresponding signal coverage requirements.

In some embodiments, the operating frequency band of the first radiation unit 221a above mentioned can be 2.3-2.7 GHz or 3.2-4.2 GHz or 4.6-5.2 GHz; the operating frequency band of the first radiation unit 221a can be further selected as 2.5-2.7 GHz or 3.3-3.8 GHz or 4.8-5.0 GHz, to achieve the required signal coverage.

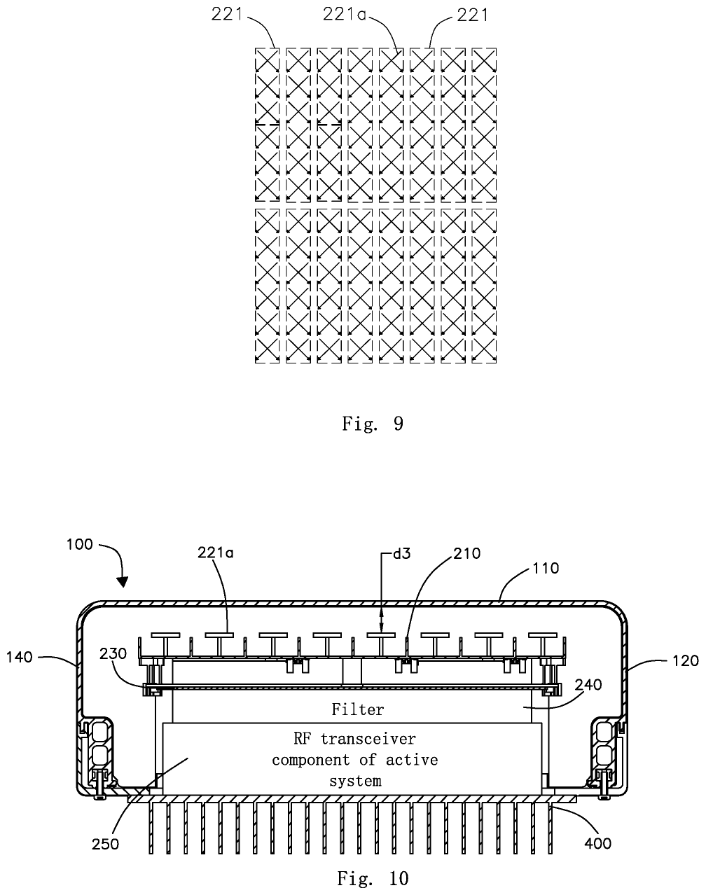

In addition, as a preferred embodiment of the present application, in the Massive MIMO array 220, the number of the first radiation units 221a of at least one sub-array 221 is different from the number of the first radiation units 221a of the rest sub-arrays 221, so as to form a hybrid arraying pattern, which may adapt to more application scenarios with better electrical performance. That is, in the same column of the Massive MIMO array 220, sub-arrays 221 with at least two numbers of first radiation units 221a may be included; between different columns of the Massive MIMO array 220, sub-arrays 221 with at least two numbers of first radiation units 221a may also be included. Specifically, referring to FIG. 8, in the same column of Massive MIMO array 220, there is not only a sub-array 221 formed by two first radiation units 221a, but also a sub-array 221 formed by six first radiation units 221a. Referring to FIG. 9, between the different columns of the Massive MIMO array 220, there is not only a sub-array 221 formed by three first radiation units 221a, but also a sub-array 221 formed by six first radiation units 221a. It should be understood that the number of the first radiation units 221a in the sub-array 221 can be selected according to the actual needs, which is not restrained herein.

In FIG. 1 to FIG. 9, a sub-array 221 is formed by the first radiation units 221a in each dashed frame.

It should be understood that according to different actual situations, the above number of columns M and the number of rows N can be selected, which is not restrained herein. The first reference axes as mentioned above refer to a plurality of reference axes set side by side in parallel.

As a preferred embodiment of the present application, referring to FIG. 1 to FIG. 4, the distance d1 between columns of the Massive MIMO array 220 as above is 0.4-0.6λ, and the distance d1 between columns is further preferably 0.52. The distance d2 between rows of two adjacent first radiation units 221a is 0.5-0.9λ, and is further preferably 0.6-0.8λ, and the distance d2 between rows is further preferably 0.7λ. In this embodiment, λ is the wavelength corresponding to a center frequency of operating frequency band of the first radiation unit 221a. Employing the distance setting as above mentioned is conducive to better electrical performance and compact structure design. It should be understood that the arraying patterns shown in FIG. 5 to FIG. 9 are also preferred to use the above distance d1 between columns and distance d2 between rows.

As a preferred embodiment of the present application, referring to FIG. 10, the distance d3 between the first radiation unit 221a and the radome 100 is ≤¼λ, where λ is the wavelength corresponding to a center frequency of operating frequency band of the first radiation unit 221a. With this distance, the height of where the first radiation unit 221a of the Massive MIMO array 220 locates can be similar to the height of where the radiation unit (specifically, the second radiation unit 321/low-frequency radiation unit 322 described below) of the antenna array 320 of the second antenna system 300 locates, which is conducive to reducing the transverse height of the radome 100 and realizing the antenna miniaturization.

As a preferred embodiment of the present application, the antenna array 320 of the second antenna system 300 includes the following arraying patterns:

The first arraying pattern: referring to FIG. 1, the antenna array 320 is formed into a column by a plurality of second radiation units 321 spaced along a second reference axis (not shown). Of course, a plurality of second radiation units 321 in the antenna array 320 can also be arranged staggered along a second reference axis. In this way, it not only has better electrical performance, but also helps to reduce the transverse width and the structure size is more compact.

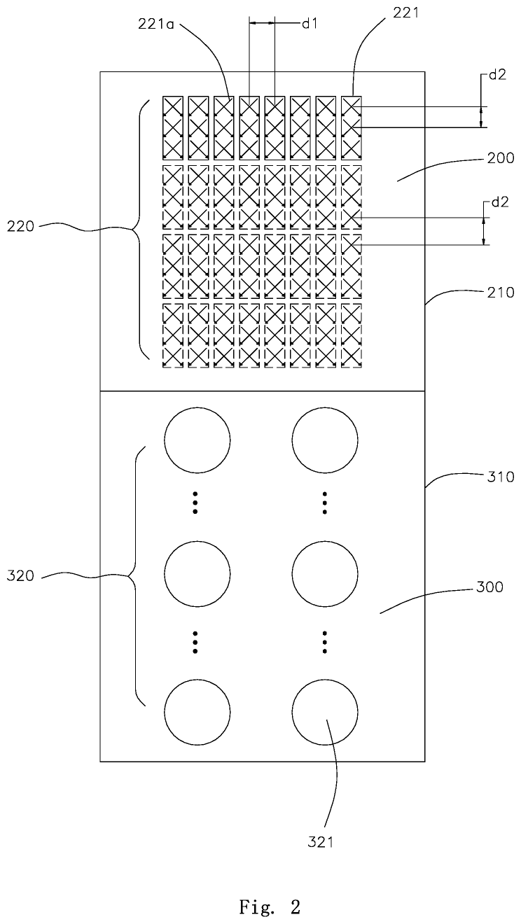

The second arraying pattern: referring to FIG. 2, the antenna array 320 is formed into two columns by a plurality of second radiation units 321 spaced along two third reference axes (not shown). Of course, a plurality of second radiation units 321 in the antenna array 320 may also be arranged staggered along the second reference axes. In addition, the two columns in the antenna array 320 can be arranged interlacing with each other. In this way, it not only has better electrical performance, but also helps to reduce the transverse width and the structure size is more compact.

In the above first and second arraying patterns, when the second radiation unit 321 is a low-frequency radiation unit 322, its operating frequency range is 690-960 MHz; when the second radiation unit 321 is a high-frequency radiation unit 323, its operating frequency range is 1.4-2.2 GHz or 1.7-2.7 GHz, so as to achieve the corresponding signal coverage.

In the first and second arraying patterns, referring to FIG. 11 and FIG. 12, a preferred embodiment is that the distance d4 between the second radiation unit 321/low-frequency radiation unit 322 and the radome 100 is ≤¼λ, where λ is the wavelength corresponding to a center frequency of the operating frequency band of the second radiation unit 321. With this distance, the height of where the first radiation unit 221a of the Massive MIMO array 220 locates can be similar to the height of where the second radiation unit 321/low-frequency radiation unit 322 of the antenna array 320 of the second antenna system 300 locates, which is conducive to reducing the transverse height of the radome 100 and realizing the antenna miniaturization. Preferably, d3 is equal to d4.

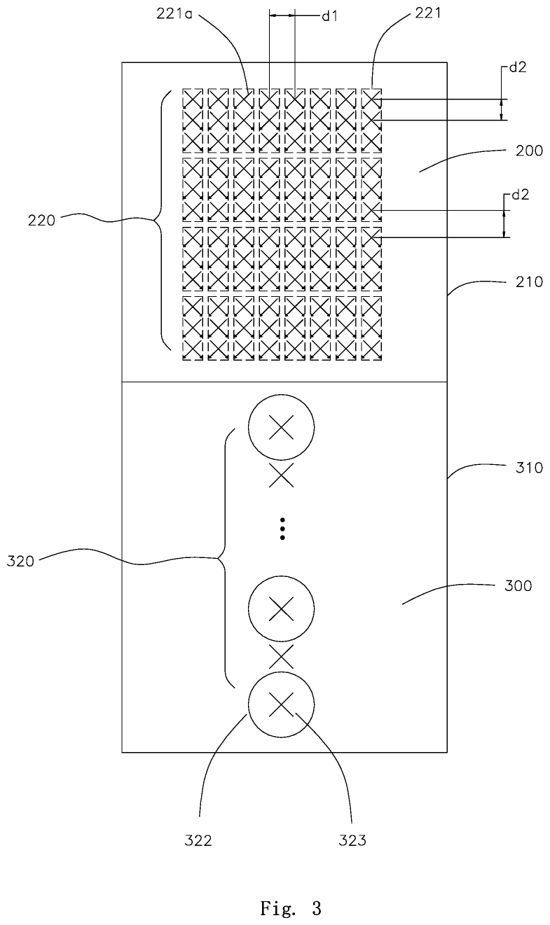

The third arraying pattern: referring to FIG. 3, the above antenna array 320 is arranged into a column along a fourth reference axis (not shown) by a plurality of low-frequency radiation units 322 and a plurality of high-frequency radiation units 323, where a portion of high-frequency radiation units 323 and low-frequency radiation units 322 are coaxial nested.

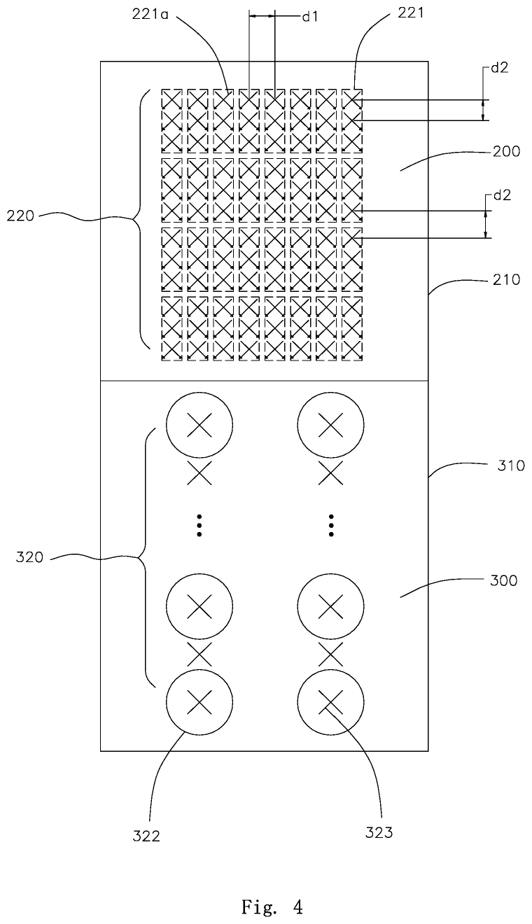

The fourth arraying pattern: referring to FIG. 4, the antenna array 320 is arranged into two columns along two fifth reference axes (not shown) by a plurality of low-frequency radiation units 322 and a plurality of high-frequency radiation units 323, where a portion of high-frequency radiation units 323 and low-frequency radiation units 322 are coaxial nested. Of course, the two columns in the antenna array 320 may be arranged interlacing with each other. In this way, it not only has better electrical performance, but also helps to reduce the transverse width and the structure size is more compact.

In the third and fourth arraying patterns mentioned above, the operating frequency band of low-frequency radiation unit 322 is 690-960 MHz, and the operating frequency band of high-frequency radiation unit 323 is 1.4-2.2 GHz or 1.7-2.7 GHz. A signal coverage for different communication network standards of 4G/3G/2G can be achieved, and it is compatible with the multi-frequency band array antennas with all the standards of 2G, 3G and 4G in mobile communication. It is conducive to the miniaturization of the antenna and the huge expansion of the application scenarios. It can reduce the number of antennas used for the base station and reduce the cost of station deployment and the cost of operation and maintenance.

In the third and fourth arraying patterns mentioned above, referring to FIG. 11 and FIG. 12, the distance d4 between the low-frequency radiation unit 322 and the radome 100 is ≤¼λ, where λ is the wavelength corresponding to a center frequency of the operating frequency band of the low-frequency radiation unit 322. With this distance, the height of where the first radiation unit 221a of the Massive MIMO array 220 locates can be similar to the height of where the second radiation unit 321/low-frequency radiation unit 322 of the antenna array 320 of the second antenna system 300 locates, which is conducive to reducing the transverse height of the radome 100 and realizing the antenna miniaturization. Preferably, d3 is equal to d4.

It should be noted that in each antenna array 320 of the second antenna system 300, the distance between adjacent second radiation units 321, the distance between adjacent low-frequency radiation unit 322 and high-frequency radiation unit 323, the distance between adjacent low-frequency radiation units 322, the distance between adjacent high-frequency radiation units 323 and the distance between two columns can be designed according to actual needs. Any adjacent radiation units do not interfere with each other, which will not be described in detail herein.

It should be noted that the above antenna array 320 can also adopt other existing arraying patterns, or even the existing arraying patterns of other intelligent antennas, which will not restrain herein.

It should be noted that all the above reference axes are the reference lines in virtual setting.

Preferably, referring to FIG. 10, the first antenna system 200 includes a first power divider network (not shown) and a calibration network 230 which are connected to the above Massive MIMO array 220, and includes a filter 240 and a RF transceiver component of active system 250 (i.e., a transceiver component known in the art) which are connected to the calibration network 230. In combination with the multi-standard integrated array antenna shown with reference to FIG. 11, the second antenna system 300 includes a second power divider network (not shown) and a phase shifter 330 which are connected to the antenna array 320. In practical application, an existing heat dissipation module 400 is further provided on the side of the RF transceiver component of active system 250 away from the Massive MIMO array 220 in the multi-standard integrated array antenna. In combination with the multi-standard integrated active antenna shown with reference to FIG. 12, the second antenna system 300 (i.e., the active antenna system) includes a second power divider network (not shown), a phase shifter 330 and a RRU 340 (i.e., a Remote Radio Unit) which are connected to the antenna array 320. In practical application, heat dissipation modules 400 are provided on the side of RRU 340 away from phase shifter 330 and on the side of RF transceiver component of active system 250 away from the Massive MIMO array 220 in the multi-standard integrated active antenna.

It should be noted that, taking a multi-standard integrated array antenna including a first antenna system 200, 4G antenna system, 3G antenna system and 2G antenna system as an example, it should also be understood that the antenna array 320 is a general term for the antenna array of 4G antenna system, 3G antenna system and 2G antenna system. The antenna array 320 can form different antennas systems by connecting with different network systems, so as to apply to the corresponding network standard.

In addition, it should be noted that, taking the multi-standard integrated active antenna including a first antenna system 200, 4G antenna system, 3G antenna system and 2G antenna system as an example, it should be understood that 4G antenna system, 3G antenna system and 2G antenna system are all active antenna systems, that is, a RRU (i.e. Remote Radio Unit) should be integrated therein so as to form a RRU integrated active antenna system. Similarly, taking the multi-standard integrated active antenna including a first antenna system 200, 4G antenna system, 3G antenna system and 2G antenna system as an example, the antenna array 320 is a general term for the antenna array of 4G antenna system, 3G antenna system and 2G antenna system. It should be understood that antenna array 320 can form different antenna systems by connecting with different network systems, so as to apply to corresponding network standard.

Preferably, referring to FIG. 1 to FIG. 4, the multi-standard integrated antenna further includes a first reflecting plate 210 and a second reflecting plate 310 successively arranged in a longitudinal direction of the radome 100. The Massive MIMO array 220 is provided on the first reflecting plate 210, and the antenna array 320 is provided on the second reflecting plate 310.

As a preferred embodiment of the present application, when the multi-standard integrated antenna is used to realize the integration of two or more different antenna systems, there may be no multiplexing portion between the Massive MIMO array 220 of the first antenna system 200 and the second antenna array 320. The first reflecting plate 210 and the second reflecting plate 310 are preferably arranged side by side from up to down as shown in FIG. 1 to FIG. 4, so as to better utilize the installation space of the radome 100. It should be understood that in this embodiment, there should be a certain distance between the Massive MIMO array 220 of the first antenna system 200 and the antenna array 320 of the second antenna system 300.

As a preferred embodiment of the present application, the first reflecting plate 210 and the second reflecting plate 310 can be detachably connected together. This can further facilitate the flexible configuration for different antenna systems according to the actual needs, so as to meet the requirements of different product combinations. After applied to any application scenarios compatible with two or more network including Massive MIMO array 220 antenna system, the reverse structure changes can be made to the assembled multi-standard integrated antenna to adapt to other application scenarios compatible with corresponding network. It greatly improves the convenience of maintenance for the multi-standard integrated antenna and the flexibility of using. It can be easier to reuse the existing base station, so as to significantly simplify the base station disposition. The resources are further saved, the difficulty of network planning is reduced, and the investment and use cost of operators are reduced. Preferably, the first reflecting plate 210 and the second reflecting plate 310 can be detectable connected by an existing connecting element. The connecting element can be an existing clamp structure, a hinge structure or other existing connection structure.

As a preferred embodiment of the present application, referring to FIG. 1 to FIG. 4, the first reflecting plate 210 and the second reflecting plate 310 are integrally molded to form a shared reflecting plate. That is, the shared reflecting plate serves as the common reflector of the Massive MIMO array 220 of the first antenna system 200 and the second antenna array 320. Such structure is more compact under the premise of ensuring the performance index, and is more convenient to manufacture and install. It is preferred that the shared reflecting plate can be designed as a rectangle to maximize the utilization of the shared reflecting plate.

As a preferred embodiment of the present application, referring to FIG. 11 and FIG. 12, the radome 100 is surrounded by a first sidewall 110, a second sidewall 120, a third sidewall 130 and a fourth sidewall 140 which are arranged successively along the circumference.

An optional structure is that the third side wall 130 includes a first wall body (not shown) and a second wall body (not shown), the first wall body is connected with the second side wall 120, the second wall body is arranged spaced with the first wall body and is connected with the fourth side wall 140, the first reflecting plate 210 and the second reflecting plate 310 each can be detachably connected between the first wall body and the second wall body. Such structure is more convenient to reconstruct the multi-standard integrated antenna according to the actual needs to meet the requirements of different network standards.

Of course, referring to FIG. 10, the radome 100 may only include a first sidewall 110, a second sidewall 120, and a fourth sidewall 140. The first reflecting plate 210 may include a bottom wall (not shown) for setting a Massive MIMO array 220, and two sidewalls (not shown) bending along the lateral two sides of the bottom wall. Referring to FIG. 11 and FIG. 12, the second reflecting plate 310 may include a bottom wall (not shown) for setting the second antenna array 320, and two side walls (not shown) bending along the lateral two sides of the bottom wall. The above two side walls correspond to the second side wall 120 and the fourth side wall 140, respectively, and are fixed by connecting with each other.

The distance d3 between the first radiation unit 221a and the radome 100 specifically refers to the distance d3 between the first radiation unit 221a and the first side wall 110 of the radome 100. The distance d4 between the second radiation unit 321 and the radome 100 refers to the distance d4 between the second radiation unit 321 and the first side wall 110 of the radome 100. The distance d4 between the low-frequency radiation unit 322 and the radome 100 specifically refers to the distance d4 between the low-frequency radiation unit 322 and the first side wall 110 of the radome 100.

The first radiation unit 221a, the second radiation unit 321, the high-frequency radiation unit 323 and the low-frequency radiation unit 322 all preferably adopt a dual polarization radiation unit, so as to improve the stability of the communication performance. Specifically, in this embodiment, the dual polarization radiation unit can be a usual ±45° polarization unit or a vertical/horizontal polarization unit, which will not be limited herein.

The first radiation unit 221a, the second radiation unit 321, the high-frequency radiation unit 323 and the low-frequency radiation unit 322 can be configured with three-dimensional space structure, and can also adopt an existing planar printing radiation unit (such as microstrip oscillator), patch oscillator or half wave oscillator or the like, and can also be a combination of any of the above antenna oscillators. When the three-dimensional space structure is adopted, the shapes of the high-frequency radiation unit 323 and the low-frequency radiation unit 322 can be rectangle shaped, diamond shaped, circular shaped, elliptical shaped, cross shaped, etc., which can be flexibly selected according to the actual needs.

It should be noted that ways of connections between the Massive MIMO array 220, the first power divider network, the calibration network 230, the filter 240 and the RF transceiver component 250 of the multi-standard integrated array system can make refernece to the prior art. Ways of connections between the second antenna array 320, the second power divider network and the phase shifter 330 can make reference to the prior art. It should also be understood that for the multi-standard integrated array antenna, the first antenna system 200 shall also include the existing structures such as heat dissipation module 400 and the like. Ways of connection of the above-mentioned first power divider network, the calibration network 230, the filter 240, the RF transceiver component 250 of the active system, the second power divider network, the phase shifter 330 and the structure such as the heat dissipation module 400 and the like or ways for connection between the structures can make reference to the prior art, which will not be described in detail herein.

It should be noted that ways of connections between the Massive MIMO array 220, the first power divider network, the calibration network 230, the filter 240 and the RF transceiver component 250 of the multi-standard integrated active system can make reference to the prior art. Ways of connections between the second antenna array 320, the second power divider network, the phase shifter 330 and RRU 340 can make reference to the prior art. It should also be understood that for the multi-standard integrated active antenna, the existing structures such as heat dissipation module 400 and the like can be included. Ways of connections between the above-mentioned first power divider network, the calibration network 230, the filter 240, the RF transceiver component 250 of the active system, the second power divider network, the phase shifter 330, the RRU 340 and the structures such as the heat dissipation module 400 or ways of connections between the structures can make reference to the prior art, which will not be described in detail herein.

The embodiments as described above are not used to limit the present application but better embodiments of the present application. Any modification, equivalent replacement and improvement made within the spirit and principles of the application shall be included in the scope of protection of the present application.

What is claimed is:

1. A multi-standard integrated antenna comprises:
a first antenna system with a Massive MIMO array;
a second antenna system with an antenna array and operating in a set network standard, the second antenna system being a passive antenna system or an active antenna system, and the set network standard being at least one of the 4G network standard, 3G network standard and 2G network standard;
the first antenna system and the second antenna system sharing a radome.

2. The multi-standard integrated antenna according to claim 1, wherein
the multi-standard integrated antenna is a multi-standard integrated array antenna, and the second antenna system is a passive antenna system; or,
the multi-standard integrated antenna is a multi-standard integrated active antenna, and the second antenna system is an active antenna system.

3. The multi-standard integrated antenna according to claim 2, wherein the Massive MIMO array includes:
a plurality of sub-arrays, which are arranged along a plurality of first reference axes to form a M×N array, wherein M and N each are natural numbers which are ≥1;
wherein if M is set as the number of columns and N is set as the number of rows, then: m≥4, n≥1; and
wherein the sub-array includes at least one first radiation unit which is arranged spaced along the corresponding first reference axis.

4. The multi-standard integrated antenna according to claim 3, wherein in the Massive MIMO array, the number of the first radiation units of at least one of the sub-arrays is different from the number of the first radiation units of the rest sub-arrays.

5. The multi-standard integrated antenna according to claim 3, wherein a distance between columns of the Massive MIMO array is 0.4-0.6λ;
a distance between rows of two adjacent first radiation units is 0.5-0.9λ;
wherein λ is a wavelength corresponding to a center frequency of an operating frequency band of the first radiation unit.

6. The multi-standard integrated antenna according to claim 3, wherein when an operating frequency band of the first radiation unit is <1 GHz, the sub-array includes one first radiation unit; when the operating frequency band of the first radiation unit is ≥1 GHz, the sub-array includes at least two first radiation units.

7. The multi-standard integrated antenna according to claim 3, wherein a distance between the first radiation unit and the radome is ≤¼λ, wherein λ is a wavelength corresponding to a center frequency of an operating frequency band of the first radiation unit.

8. The multi-standard integrated antenna according to claim 2, wherein the antenna array is arranged into a column by a plurality of second radiation units which are spaced along a second reference axis;
or, the antenna array is arranged into two columns by a plurality of the second radiation units which are spaced along two third reference axes;
or, the antenna array is arranged into a column by a plurality of low-frequency radiation units and a plurality of high-frequency radiation units along a fourth reference axis, wherein a portion of the high-frequency radiation units and the low-frequency radiation units are coaxially nested;
or, the antenna array is arranged into two columns along the two fifth reference axes by a plurality of low-frequency radiation units and a plurality of high-frequency radiation units; wherein a portion of the high-frequency radiation units and the low-frequency radiation units are coaxial nested.

9. The multi-standard integrated antenna according to claim 8, wherein an operating frequency band of the second radiation unit is 690-960 MHz or 1.4-2.2 GHz or 1.7-2.7 GHz.

10. The multi-standard integrated antenna according to claim 8, wherein an operating frequency band of the low-frequency radiation unit is 690-960 MHz, and the operating frequency band of the high-frequency radiation unit is 1.4-2.2 GHz or 1.7-2.7 GHz.

11. The multi-standard integrated antenna according to claim 8, wherein a distance between the second radiation unit and the radome is ≤¼λ, wherein λ is a wavelength corresponding to a center frequency of the operating frequency band of the second radiation unit.

12. The multi-standard integrated antenna according to claim 8, wherein a distance between the low-frequency radiation unit and the radome is ≤¼λ, wherein λ is a wavelength corresponding to a center frequency of an operating frequency band of the low-frequency radiation unit.

13. The multi-standard integrated antenna according to claim 2, wherein,
when the multi-standard integrated antenna is a multi-standard integrated array antenna, the first antenna system further includes a first power divider network and a calibration network which are connected to the Massive MIMO array, and includes a filter and a RF transceiver component of active system which are connected to the calibration network; the second antenna system further includes a second power divider network and a phase shifter which are connected to the antenna array;
or, when the multi-standard integrated antenna is a multi-standard integrated active antenna, the first antenna system further includes a first power divider network and a calibration network which are connected to the Massive MIMO array, and includes a filter and a RF transceiver component of active system which are connected to the calibration network; the active antenna system includes a second power divider network, a phase shifter and a RRU which are connected to the antenna array.

14. The multi-standard integrated antenna according to any one of claims 2-13, wherein the multi-standard integrated antenna further includes a first reflecting plate and a second reflecting plate which are arranged successively along the longitudinal direction of the radome; the Massive MIMO array is provided on the first reflecting plate and the antenna array is provided on the second reflecting plate.

15. The multi-standard integrated antenna according to claim 14, wherein the first reflecting plate and the second reflecting plate can be detachably connected together;
or, the first reflecting plate and the second reflecting plate are integrally molded to form a shared reflecting plate.
